(19) United States
(12) Patent Application Publication
(10) Pub. No.: US 2008/0270104 A1
(43) Pub. Date: Oct. 30, 2008

(54) System and Method for Creating an Assurance System in a Mixed Environment

(76) Inventors: Robert J. Stratton, Vienna, VA (US); John Hawley, Fairfax, VA (US); Andrew Gross, Campbell, CA (US); Carolyn Turbyfill, Fairfax, VA (US); John Clemens, Columbia, MD (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/772,667

(22) Filed: Jul. 2, 2007

Related U.S. Application Data
(60) Provisional application No. 60/939,584, filed on May 22, 2007.
(60) Provisional application No. 60/913,803, filed on Apr. 24, 2007.

(51) Int. Cl. G06F 9/455

(52) U.S. Cl. 703/23

(57) ABSTRACT

An assurance system for evaluating a target application environment using a mixed environment including a virtual environment and the target environment. The assurance system emulates and evaluates the target environment. Information such as network configuration, interface information, and software packages or subsystems are imported into the virtual application environment. The assurance system may be used for purposes of testing, and delivering comprehensive reports of the likely results on the target system based on a comparison of the virtual application environment to the target environment, including such things as configuration changes to the environment, environment load and stress conditions, environment security, software installation to the environment, and environment performance levels among other things.

### CROSS REFERENCE TO RELATED APPLICATIONS

This application claims priority to U.S. Patent Application Ser. No. 60/939,584 filed on May 22, 2007 and U.S. Patent Application Ser. No. 60/913,803 filed on Apr. 24, 2007 both of which are hereby incorporated by reference herein in their entirety.

### BACKGROUND OF THE INVENTION

The present invention relates to the creation of an assurance system.

In many computer systems, and in particular businesses, a plurality of applications, running simultaneously on a plurality of computers such as servers usually connected to the same network, is used to provide business services to staff and/or customers. The various applications allow the system to perform a variety of tasks simultaneously and provide information to a plurality of users at the same time. Thus, a system may have an e-mail application running on a network at the same time as a document management application, both of which may be running on separate servers. Any user of the system is able to utilize the various applications at the same time on any computer connected to the system.

When a system administrator wishes to update a particular application on the system or install a new application on the system, the installation may require one or more users to cease using the system for a period of time. This results in a decrease in productivity that may be quite significant in business environments depending on the number of users who are required to cease using their applications and the amount of time that the applications are not available.

Quite often, the installation of new applications or the update of existing applications leads to unforeseen difficulties on the computer systems, such as inhibited functionality of other applications, unanticipated interaction of the new software with the computer network, or hardware difficulties. Application complexity is increasing such that software faults will always exist. Software authors and vendors are unable to adequately evaluate all conditions in which their software will operate to properly determine whether errors exist. Additionally, specific conditions existing only in a particular customer environment may emerge and cause or reveal faults or failures about which the product vendors may have no knowledge or insight. Once problems are discovered, repair of these problems is often time consuming. These issues lead to increased delays in allowing users to utilize the system and thus decreased productivity.

The installation of new software may also inadvertently damage data on the system, leading to lost productivity, frustration of users or monetary loss.

In some business systems, such as banking systems, electronic commerce storefronts, or cable television systems, servers that provide information to customers and manage the activities of the business must function at all times and cannot be taken offline for maintenance. These systems are often constructed of multiple, interdependent systems and software, often referred to as “n-tiered” or “multi-tier” applications or an “application stack”. Improper operation of any individual software or hardware component or interconnection may render the entire business application inoperative or unavailable. Installation of new applications or the update of software on the systems may cause disruptions in service, which can cost such businesses immense amounts of money.

With the advance of computer networking, network security has become a great concern, particularly for businesses. Unauthorized users may access computer networks to obtain data to be used in an illegal manner or to tamper with a business's data. As a result of security concerns, network administrators employ security software to restrict the network to only authorized users.

Because new computer viruses and worms frequently emerge on the Internet, security software must be updated frequently to protect networks from these threats. These updates are often difficult or time-consuming to implement on systems without causing losses in user productivity.

System administrators also must evaluate the servers and computers attached to the system for security concerns so that they may be repaired before unauthorized users exploit them. The search for these security concerns, however, may be time consuming and may interfere with a user's ability to utilize the system, inhibiting the ability of a business to adequately utilize their resources. Some security tests that emulate hostile network activity can at times cause failures in neighboring non-target systems simply by virtue of the intensity of the test and the proximity of the neighboring systems to the system under test.

The tools used by administrators to evaluate system security and reliability are continually evolving, and it is necessary to install software updates for them on a regular basis in order to receive accurate results. These are often individually managed, and toolkits assembled from individual components.

There is a need for a system that provides a consistent interface for test and evaluation operations against systems and that facilitates the automatic updates on a regular basis of key test software.

The testing or staging, prior to release, of business application systems is considered an operational “best practice.” The ideal example of this is the deployment of an exact duplicate, in hardware and software, of the system to be deployed. Practical realities of hardware cost, facility requirements, and staff time limitations often prevent the deployment of such duplicate environments.

There is a need for a system that will allow users and/or system administrators to determine the possible adverse effects of system configuration change, installing new software or updating existing software while causing a minimal amount of interference with users of a computer system or network.

Because system administrators have limited time to address system problems, there is a need for a system that will provide a rapid ability to perform, from one or more centralized platforms, a range of evaluations on one or a plurality of systems across a variety of conditions, including configuration, reliability, security, and compliance with best practice mandates.

There is a need for a system that will provide unified reporting, to multiple classes of users (i.e. management, operations, security, and compliance), on the operation of an entire business application and its constituent components, across multiple conditions.

Systems administrators commonly resolve problems within their own organization, based on institutional knowledge that, while potentially considerable, is limited to that discovered within only one organization.

There is a need for a system that can aggregate and deliver insight into interoperability problems, potential resolutions, and warning indicators of potential failure from a larger population of users who share operational challenges, while preserving the privacy of their organizations.

### SUMMARY OF THE INVENTION

The present invention is a system and method for creating an assurance system.

In one embodiment, the present invention is a system for creating and analyzing a virtual application environment that is identical to the environment on a particular target system such as, for example, a network, an entire enterprise architecture or branch thereof, a particular network server, or a workstation. The assurance system may consist of software adapted to copy the entire memory and various settings of the target system to a location separate from the target system.

When the assurance system copies the memory of the target system, it preferably copies the entire contents of every memory device attached to the target system such as, for example, hard disk drives and read-only memory devices. This ensures that the virtual application environment has access to all of the information that the target system has access to.

The software may copy the memory of the target system over a network to the separate location or directly to another computer or portable storage device. The software may also capture details of the network interconnections between components of the target systems.

Once the memory, settings, and network information from the target system have been copied, the assurance system uses the copied memory to create a virtual application environment in a location separate from the target system that functions in the same way as the target system. Although running on separate hardware, the virtual application environment will be practically indistinguishable from the target system or systems. Specific hardware or network attributes of target systems may be emulated by the virtual application environment to facilitate accurate representation of unique characteristics of the target when running in the virtual application environment. The assurance system will have access to all of the applications and data stored on the target system because the entire memory and configuration of the target system is copied.

The virtual application environment may also be created on the same hardware as the target system, but in a designated area, such as a partition or dedicated portion of a storage area network.

In this embodiment, the virtual application environment is simply isolated from the target environment using software. Isolation, however, may not always be desired. For example, in one embodiment input that is sent to the target system may simultaneously or on a delayed basis be sent to the virtual application environment so that a user may test how the virtual application environment functions differently from the target system, particularly after new software has been installed.

In one embodiment, the virtual application environment may be connected to the same network as the target system in order to simulate interaction between the virtual application environment and the physical network. Network traffic may be routed from the network to both the target system and the virtual application environment, with only the target system being allowed to return responses to the network. A firewall or other security may be set up to prevent the virtual application environment from sending output to the network. The virtual application environment may also be connected to the same hardware devices as the target system, particularly if any difficulty has occurred in the past with a particular piece of hardware

In one embodiment, the assurance system will provide a capability for the virtual application environments to interact with network resources, including name servers, time servers, file server or databases, outside the assurance environment while the target system's network and the virtual network share conflicting configuration parameters, such as duplicate IP addresses, which would normally prohibit interoperability. This may be accomplished in the assurance system through the use of network address translation, network service proxy servers or other technologies. For example, some network appliances use proprietary hardware and software that cannot be virtualized unless the vendor provides a virtual instance of the appliance. In this case, to test an application environment's interoperability with the appliance, the assurance environment would have to interact with the physical appliance on the network. Another example would be a database or storage network that is too large to import into a virtual environment. If the database were a production database where a test could not be allowed to compromise the integrity of the data, tests could be limited to read-only queries or may be restricted to accessing a special set of test data that would only be used for testing and could not compromise the integrity of the production data. This could be accomplished by having a set of users with database access privileges that would be appropriately restricted.

In another embodiment, the system merely simulates hardware devices that would be accessible to the target system. For example, the virtual application environment may have access to a virtual printer, which consists of a software program that communicates with the virtual application environment in the same manner as a physical printer.

In another embodiment, software representations of virtual network components such as routers, firewalls, or network load balancers may be added to the virtual network inside the virtual application environment. In order to provide the best possible test fidelity, these components may be derived from the product code base of the physical network components being replicated within the virtual network inside the assurance system.

In one embodiment, the system according to the present invention will send simulated input, which simulates input that would be received by the target computer to the assurance system in order to properly test the virtual application environment in real conditions.

In another embodiment, actual input that is received by the target system is simultaneously sent also to the assurance system in real time so that a user may compare and monitor the functionality of the virtual application environment with the functionality of the target system using the same inputs.

The assurance system may also retrieve or accept information about the target systems from tools used to manage target systems including but not limited to configuration management applications, systems management applications, audit and compliance tools, performance sizing and simulation tools, and vulnerability scanners.

In some embodiments, one or more components of a large, complex target system environment may not be imported into the assurance system. In these embodiments, the assurance system will provide connectivity mechanisms to allow a virtual application environment to interoperate with one or more application and/or network service components running outside of the assurance system. An example would be a database server running outside the assurance system, providing networked database management system services to a virtual application environment running inside the assurance system.

In one embodiment, the assurance system may copy a plurality of target systems and manage a plurality of virtual application environments. The virtual application environments may be created from various different environments on various different devices. This may be useful when a user wishes to determine how changes to one machine will affect other machines that function in conjunction with, or depend upon, the changed machine. This embodiment may also be useful to simultaneously compare the environments and attributes of multiple machines and environments, possibly through a network.

Once the virtual application environment has been created, the user may use the assurance system for a plurality of uses. The user may run a series of security tests on the virtual environment to attempt to penetrate the security on the computer using network security testing or “hacker” tools. If the user is successful in penetrating the security on the virtual application environment, the user knows that it must update the security on the target system. Because the tests are run on the virtual application environment, any damage to stored data caused by the testing will not effect user productivity because the data on the target system are never accessed.

If a security flaw is detected in the virtual application environment, the system may generate a patch, or programmed fix, to correct the flaw. We define a fix to be any change that will mitigate a failure. A fix can any means of mitigating a flaw such as a configuration change, a component designed to intercept bad input such as an application firewall, or a patch. We define a patch to be a subset of a fix, specifically a change to an applications code designed to eliminate an application flaw that is the root cause of a vulnerability or failure. The user may then run the patch on the virtual application environment to ensure that it will not have any adverse effects on the functionality of the virtual application environment or on the data stored by the virtual application environment. The user may then run tests on the virtual application environment to ensure that the patch remedies the security error. If the patch remedies the error, the patch may be applied at a later time to the target system.

Because all of the testing is run on the virtual application environment and not the target system, another user may utilize the target system while the testing is taking place. This means that the target system is being effectively utilized which maximizes productivity.

In another embodiment, the virtual application environment may be used in a forensics mode, where the user is able to pause and step through an application using forensics tools for purposes of determining the root cause of a system failure or performance anomaly. The assurance system provides a means of integrating analysis and assurance tools from a variety of sources ranging from custom user-specific tools to commercial or open source products.

A user may also use the virtual application environment to install new software or update existing software. This allows the user to determine how the new software will interact with the existing software on the target system without actually occupying or shutting down access to the target system, leaving it operational for another user to access and utilize while the installation occurs on the virtual environment. In the case of a security test that may corrupt the virtual environment under test, the virtual environment may be configured to isolate it from the user's network.

A user may utilize the assurance system to release a virus on the virtual application environment to assess the effect that a virus would have on the machine if a virus ever penetrated the security of the machine. The results of such a test may be useful to a system administrator who is considering the cost and benefits of installing new virus protection software. The virtual environment may be configured to isolate it from the user's network to prevent damage from the virus.

A user may use the virtual environment to evaluate the efficiency of the target system by, for example, removing or replacing selected applications on the virtual environment. The user may run a plurality of tests on the virtual environment to evaluate how to improve the speed of the virtual environment. If the system determines that changes may be implemented to improve the speed of the virtual environment, the system may suggest these changes to the user. The user may then implement the changes, evaluate the changes, and decide whether or not to implement the changes on the target system.

In one embodiment, the software used to perform tests or evaluate the virtual environment is installed in the virtual environment. The software is installed in such a way, however, as to avoid any impact on testing accuracy. The software may be isolated from the virtual environment. The software itself will be undetectable when evaluations or testing is performed. The software may compensate for the effects on the comparison resulting from the software being installed in the virtual environment.

If a fault or failure, including performance degradation, is detected in the virtual application environment, the system identifies which program is the source of the fault and may generate a patch, or programmed fix, to correct the flaw. The user may then run the patch or fix on the virtual application environment to ensure that it will not have any adverse effects on the functionality of the virtual application environment or on the data stored by the virtual application environment. The user may then run tests on the virtual application environment to ensure that the patch remedies the performance problem. If the patch or fix remedies the error, the patch or fix may be applied at a later time to the target system. The identification of the flaw, the remedy designed, and the effectiveness of the remedy are all added to a report and provided to a user. The report or the remediation information may also be stored for review at a later time if a similar error occurs on the same machine or a different machine with the same application. The report may also be stored and automatically recalled at a later date if the user creates a virtual application environment from the same machine. At a later time, the report may provide the user with remediation measures that were taken in the past on this machine or on other machines that experienced similar problems, had similar configurations, utilized similar applications, interfaced with similar devices, or for any other reason, and suggest possible remediation measures or other changes to the workstation based on the report and/or based on the assurance system's knowledge base. For example, if a report states that a defragmentation was performed on a workstation last year and the defragmentation increased the workstation's efficiency, the system may suggest that the user perform another defragmentation on the workstation. The report may also be useful to a system administrator who wishes to evaluate the number of flaws a particular software application has had in the past.

In one embodiment, testing or analysis tools included or compatible with the assurance system may be deployed on systems within a production environment, with or without some alteration to minimize the tools' impact on the performance and functionality of the production systems. In this embodiment, these tools may report faults or issues to the assurance system where more invasive detection and diagnosis of an issue may be performed against a virtual application environment corresponding to the production environment. When proposed fixes are identified for the faults or issues, they may be tested against the virtual application environment prior to deployment in the production environment.

A user may create and store an initial baseline virtual application environment at a given date and use it at a later date to compare to a second virtual application environment created from the same target system. This allows the user to evaluate changes that have been made to the target system and determine exactly how the changes have affected the performance of the target system.

For example, a baseline initial virtual application environment of a target system such as a World-Wide-Web (HTTP) server may be created and stored when a website is first deployed. At a later date, such as a year after the initial deployment, a second virtual application environment will be created and compared to the first. This will allow a user to evaluate how operations or security personnel have changed the environment since the initial deployment, such as by installing additional software or configuration changes, whether those changes are caused through user action, malicious software, or input that exploits a system vulnerability.

A user may also wish to compare, over time, multiple target systems that were identical at the time of initial deployment. Though originally identical, poorly-documented system configuration changes made by administrators in the heat of incident resolution may cause “configuration drift” in these supposedly identical systems. Some of these changes may have caused certain servers to become more or less reliable or secure than others, without an obvious indication of the reason.

For example, a baseline virtual application environment for a redundantly deployed network server such as a network load balancer, web server, or application server may be taken at the time of initial deployment. Later, after a period of continuous operation, multiple instances of virtual application environments from these originally replicated systems may be created and compared to the baseline to reveal undocumented configuration changes that enhance or adversely affect system performance.

The system may also be used to compare two virtual environments created from two separate target systems that reside on the same network. This type of comparison may be especially useful where one of the users of the virtual environments is experiencing problems with one or more applications on one of the target systems. A user may use the system to compare two potentially dissimilar virtual environments, determine the differences between the two environments, and evaluate the problem environment to determine how to remedy the error.

The system may store a plurality of virtual environments from a number of similar target systems such as computers connected to a common network, local area networks, or wide area networks, and possibly even refresh or update them periodically, in order to generate reports showing the various attributes of the computers, their software, and the interoperability of multiple components.

A user may utilize an assurance system to evaluate the possible functionality and repercussions of installing a new piece of hardware to a target system. The user first creates a virtual environment from the target system using the system software. Then the user may install the hardware on the virtual environment and run test programs on the virtual application environment to determine how the new hardware will affect the target system if it is installed on the target system.

The assurance system may be used to detect operating system errors, server errors, database errors, or virtually any other errors that may occur on a target system. The system may also run tests to uncover possible future errors that may occur before they ever cause any disruption on the target system.

The present system for creating an assurance system may also function on only a single computer. In this embodiment, the system creates a virtual application environment in a separate storage area, such as a partition, on the same computer. Tests and changes may be run by the assurance system on the virtual application environment without interfering with the normal storage and applications of the computer.

In one embodiment, the assurance system may be used to apply programmatic or manual changes to modify the configuration of the virtual application environment and determine the results of the modified configuration. If the user determines that the changes improve the performance of the virtual application environment with no adverse effects, the changes may then be applied to the analogous target system in the production environment without fear of adverse effects.

The present system may also be used to create and store one or more virtual environments as backup systems that may be utilized in the case of a failure of the target system. In this embodiment, the assurance system may provide functionality that allows the contents and configuration of a virtual application environment to be copied to one or more physical target systems that are external to the assurance system.

In one embodiment, software according to the present invention may capture system software configuration data, fault information, and user-contributed information on fault mitigation strategies and maintain a knowledge base of fault and fix information. In this embodiment, the system would, given user authorization, collect fault and fix information from individual users of the system, remove private information from the data, and upload the information to a central repository. From this repository, updates to all other customers knowledge base systems would be derived, and delivered, via a mechanism such as a network connection or recorded media. Other information products would also be derived from this data and published for the benefit of the user community.

In one embodiment illustrated in FIG. 6, the knowledge base may accept information from, and deliver information to, other enterprise support systems, such as patch management systems, trouble ticket systems, or vulnerability databases such as Common Vulnerabilities and Exposures, a database known in the art which can be found at http://cve.mitre.org and is hereby incorporated by reference herein in its entirety, and best practices for security, programming, information technology processes and system configuration. This may be done via a variety of mechanisms such as application programming interfaces, network services, or updates from vendors or software providers via network feed or any form of media such as, for example, DVD's.

In one embodiment, the knowledge base may store configuration data for virtual application environments it has imported in the past or for machines connected to the same network as the knowledge base. The system may use this information to suggest configuration changes to a user based on the configurations of other machines and the performance of the other machines. The system may also use this information to generate reports concerning the functionality of the various machines evaluated by the assurance system and how the performance of any particular machine or machines may be improved. The knowledge base may also compare reports to prior reports that have been created and stored in the past regarding a particular machine.

In one embodiment, the invention is a method for evaluating a first computer environment comprising copying data stored in the first computer environment to a virtual computer environment, copying configuration data from the first computer environment to the virtual computer environment, emulating components from the first computer environment in the virtual computer environment, analyzing the first computer environment and analyzing the virtual computer environment using a software program located in the virtual computer environment, and comparing the first computer environment to the virtual computer environment at a first point in time based on the analysis of the first computer environment and the analysis of the virtual computer environment. The method may further comprise comparing the first computer environment to the virtual computer environment at a second point in time. The method may further comprise creating a report based on the comparison of the first computer environment to the virtual computer environment at the first point in time and the comparing of the first computer environment to the virtual computer environment at the second point in time. The comparing of the first computer environment to the virtual computer environment at the first point in time may yield a first set of results, and the comparing of the first computer environment to the virtual computer environment at the second point in time may yield a second set of results, and the method may further comprise comparing the first set of results to the second set of results.

In one embodiment, a method according to the present invention may further comprise installing a hardware component on the virtual computer environment. The hardware component may be a virtual hardware component. The first computer environment may then be compared to the virtual computer environment a second time.

In one embodiment of a method according to the present invention the virtual computer environment is created on dissimilar hardware from the hardware of the first computer environment.

In one embodiment of a method according to the present invention the emulating of components from the first computer environment in the virtual computer environment comprises emulating components in the virtual computer environment that are different than the components of the first computer environment. The method may further comprise modifying the virtual computer environment and comparing the first computer environment to the virtual computer environment a second time. The modifying of the virtual computer environment may comprise installing software on the virtual computer environment, installing a hardware component on the virtual computer environment, or adding data to the virtual computer environment.

One embodiment of a method according to the present invention may comprise the routing of simulated network traffic to the virtual computer environment. In another embodiment, live network traffic, such as production traffic or actual transaction traffic, may be routed to the virtual computer environment. In an additional embodiment, network traffic, either the same or different, may be routed to both the first computer environment and the virtual computer environment. In one embodiment, the same traffic may be duplicated and sent to both the first computer environment and the virtual computer environment while both environments are monitored and compared. In this embodiment, one of the environments may be modified and the comparison will show the effect of the modification.

In one embodiment, a method according to the present invention may comprise removing software from the virtual computer environment and/or removing software from the first computer environment.

A method according to the present invention may further comprise compensating for the effects on the comparison resulting from the software program located in the virtual computer environment.

A method according to the present invention may further comprise modifying the first computer environment based on the analysis of the first computer environment and the analysis of the virtual computer environment.

In one embodiment, the present invention comprises a system for evaluating a first computer system, comprising a first computer system including a first memory device wherein the first memory device includes data and configuration settings, a second computer system, including a second memory device wherein the data and configuration settings from the first memory device are copied to the second memory device to emulate the first computer system in the second computer system, and a computer software program on the second computer system that is used to compare the first computer system to the second computer system. The system may further comprise additional software installed on the second computer system which is not present on the first computer system. The system may further comprise an additional hardware device installed on the second computer system which is not present on the first computer system.

The system according to the present invention may further comprise a report generated by the computer software program.

The results of the comparison performed by the computer software program may be stored on the second computer system.

The computer software program may run a script on the second computer system.

In one embodiment, the present invention comprises a method of comparing a first computer environment with a second computer environment comprising copying data stored in the first computer environment to the second computer environment, copying applications stored in the first computer environment to the second computer environment, and comparing the first computer environment to the second computer environment using software installed on the second computer environment. The method may further comprise installing software on the second computer environment that is not present on the first computer environment.

A method according to the present invention may further comprise installing a hardware component on the second computer environment that is not present on the first computer environment.

A method according to the present invention may further comprise compensating for the effects on the comparison resulting from the software being installed on the second computer environment.

A method according to the present invention may further comprise compensating for the effects on the comparison resulting from the computer software program on the second computer system.

A method according to the present invention may further comprise modifying the first computer system based on the comparison of the first computer system to the second computer system.

A method according to the present invention may further comprise modifying the first computer environment based on the comparison of the first computer environment to the second computer environment.

### BRIEF DESCRIPTION OF THE DRAWINGS

FIG. 1 is a flow diagram depicting a method of creating a virtual application environment according to the present invention.

FIG. 2 is a flow diagram depicting a method of assessing the security of a target system using a virtual environment according to the present invention.

FIG. 3 is a flow diagram depicting a method of assessing a software implementation on a target system using an assurance system.

FIG. 4 is a flow diagram depicting a method of remedying flaws in a computer environment.

FIG. 5 is a system diagram depicting the various components of an assurance system according to the present invention.

FIG. 6 is a system diagram showing various systems of the present invention in communication with the knowledge base in one embodiment.

FIG. 7 depicts one embodiment of a user interface according to the present invention.

FIG. 8 depicts the simultaneous flow of network traffic to a target system and a virtual application environment according to one embodiment of the present invention.

FIG. 9 depicts one embodiment of an assurance system managing various virtual environments according to the present invention.

FIG. 10 depicts one embodiment of a user interface according to the present invention in communication with a plurality of assurance systems.

FIG. 11 depicts one embodiment of an enterprise management station according to the present invention in communication with a plurality of assurance systems.

### DETAILED DESCRIPTION

The present invention is a method and system for creating an assurance system, which creates and analyzes a virtual application environment that is identical to a target environment. The assurance system may then be used to assess the effect of contemplated changes, run tests, create reports, or install new software without interfering with the target environment.

The target environment to be emulated may be a computer, a workstation, a personal digital assistant, a cellular telephone, a user interface device, a server, an entire network, an entire enterprise system comprised of multiple servers, or any other electronic device. The target environment may be a plurality of devices such as, for example, a number of servers that together provide a business service, or a number of cable television receivers connected to a system.

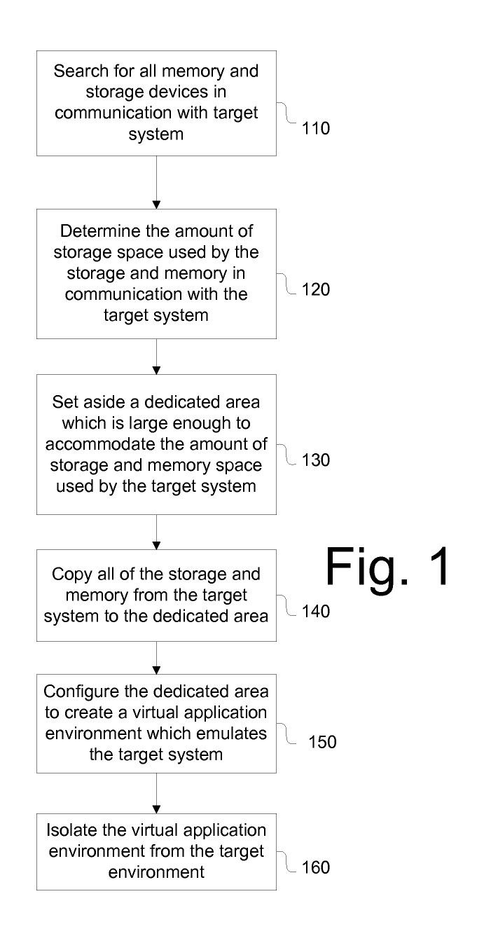

A method of creating an assurance system according to the present invention is depicted in FIG. 1. To create a virtual application environment that mirrors the target environment, software according to the present invention searches for all storage devices attached to the target environment 110. Once all storage devices have been identified, the software searches for the amount of storage space used on the storage devices or occupied by the target environment 120. Once the amount of space has been determined, the software will set aside an area of memory to create the virtual system that is large enough to accommodate all of the storage used by the target system 130.

The area set aside by the software, or dedicated area, may be in any location depending on the amount of storage needed and the target system to be copied. The dedicated area may be on the same system as the target system, such as the same network, or may be on a separate device or network. For example, if a user simply wants to create a virtual environment replicating a personal computer environment, they may simply create a virtual environment on a flash memory device. The dedicated area may be distributed across various devices or memory locations. In another embodiment, if a user wishes to create a virtual environment replicating a server on a storage area network, an area on another server may be used as the dedicated area.

Once the dedicated area has been set aside, the software copies the entire contents of all storage devices, including for example, hard disk drives and read-only memory, to the dedicated area 140.

The software also copies the details of network settings in order to reproduce the network configuration of the systems being copied.

The software will then configure the dedicated area according to the configuration files or settings of the target area so that the dedicated area will function in the same way as the target area, becoming the virtual application environment 150. A virtual wall may be set up to separate the dedicated area from the target area if necessary, for example, where the dedicated area is on the same network as the target area 160. In some embodiments, the software may create virtual devices that emulate the various memory areas, storage devices connected to the target system, or other virtual hardware components. For example, the software may create a virtual hard drive that communicates with the virtual system in the same way as a hard drive in the target system does.

In one embodiment, the system may provide a means of storing changes to an initial baseline virtual application environment through the use of copy-on-write technology or overlays, to reduce the (potentially large) overall storage requirements for multiple versions of the virtual application environments. In this embodiment, when running a version of a virtual application environment that has been modified since the time of initial creation, the storage system drivers will “read-through” a set of stored change data or “deltas” and apply them dynamically to the baseline dataset being read. This presents the appearance to the system of reading a new version of the dataset, while only requiring the storage of the initial baseline set and specific changed data.

In one embodiment the system imports a number of machines into the assurance system and may simultaneously test or compare the virtual application environments created from the machines. In this embodiment, a user may test how changes to one virtual application environment may impact a second virtual application environment or simply implement a single change on a number of virtual application environments and evaluate how the machines are each affected. For example, a user may wish to evaluate the impact of running three applications on one particular machine as opposed to running them on three separate machines. In this embodiment, a user may access, evaluate, and manipulate multiple virtual application environments through a single user interface. The user interface may allow a user to run tests on a particular virtual application environment, a particular software application across a number of machines, a particular hardware device utilized by one or more machines, or a select group of the virtual application environments. The user may create reports for any tests run or create aggregated reports that summarize the result of two or more tests. For example, a “Security Report” may contain the results of a plurality of tests that attempt to breach the security of the system. A “Comparison Report” may contain all of the differences between two or more virtual application environments.

The software used to run the assurance system and perform evaluations and tests of the virtual application environment may be located in the virtual application environment. This software will be isolated from the virtual application environment so that it is undetectable by the analysis components of the assurance system to ensure that the software itself does not effect the evaluations or tests. The software may compensate for the effects on the comparison resulting from the software being installed in the virtual environment. In one example of this compensation, when a program is evaluating the amount of memory used by a particular virtual environment, the program may subtract the amount of memory used by the software used to run the assurance system. In another example of this compensation, when an evaluation program is evaluating the functionality of a processor, including the speed of the processor in performing certain tasks, the program may compensate for the amount of processing required by the evaluation program itself.

In one embodiment, performance of a single computer environment may be evaluated at different times by creating a plurality of virtual machines from the single computer environment at different points in time and comparing the plurality of virtual machines. During this evaluation, it may be sufficient to simply determine relative changes in performance or resource usage in the plurality of virtual computers. In this case, rather than compensating for resource usage of the virtual assurance environment software, it is possible to simply insure that the overhead is the same when comparing test results for two systems. For example, the assurance system can determine which processes outside of the system being tested were running in the assurance environment the last time the test was run, and insure that exactly the same processes are running when the test is repeated on a different instance of the target system. Likewise, memory and CPU allocation for the system being tested and for the virtual assurance environment should be the same. In this example a relative comparison of the performance and resource usage of the systems being tested is valid, even if the test results are not a precise predictor of how the system would perform in production. Furthermore, if there are performance and resource utilization metrics that can be obtained in production, prior to importing a system into the virtual assurance environment, the same metrics can be obtained in the virtual assurance environment, providing a virtual/real ratio that can be used to predict how a virtual metric can be adjusted to predict what the physical metric in production would be.

The assurance system may also be accessible to a number of users at different computers or different locations on a network. This allows each user to access the assurance system through a user interface and run tests or evaluations on the virtual application environments. The system contains a library of virtual application environments which may be managed by users. The user can add, delete or change a virtual application environment. The user may also create a backup version of a virtual application environment before a change is made. The original virtual application environment imported from a target physical system may be kept as a baseline version and in some embodiments must be explicitly deleted by a user. Each user may be given different permission levels such that a particular user may be able to run only passive tests while another user may able to run active tests such as the installation of software or the modification of files. Certain users may also only have access to certain virtual application environments or certain applications in the virtual environment to ensure that confidential data stored on one or more virtual application environments is not provided to unauthorized users.

In this embodiment, the system also allows a near-instantaneous “reversion” capability after changes, as the base data are never changed or completely recopied and always available for use. In this embodiment, graphical user interface elements may provide visual cues as to original versions and changed versions of virtual application environment data.

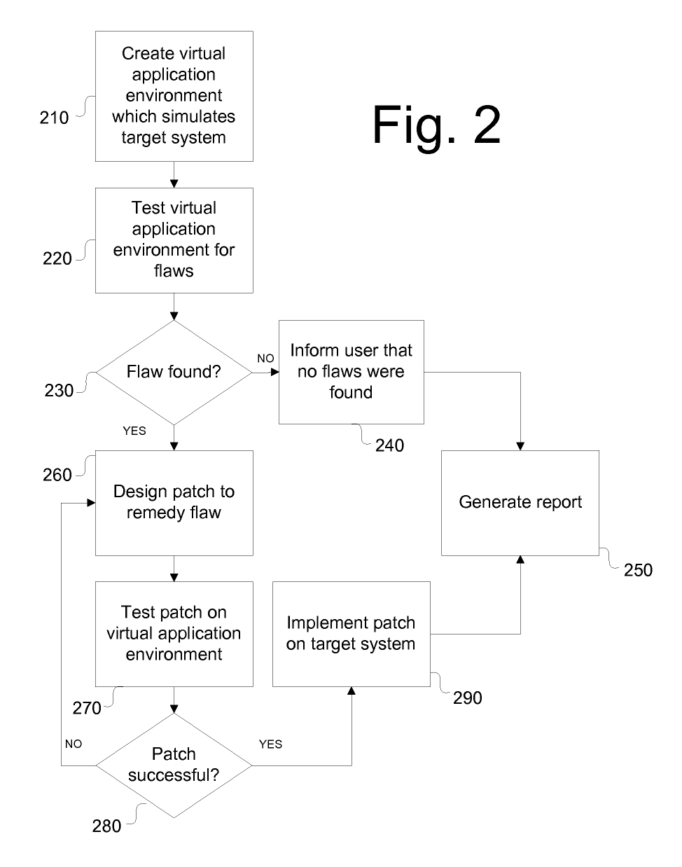

In one embodiment, the present invention is a method of searching for reliability or security flaws on a target system and determining the effect of patching the flaws as depicted in the flow diagram of FIG. 2. A user first creates a virtual application environment emulating the target system according to the method described above 210.

Once the virtual application environment has been created, the user runs the virtual application as if it were running in its regular environment. The user may then use software external to the virtual application environment to test the virtual application environment for reliability or security flaws 220. This analysis software may reside in the assurance system, and multiple analysis or testing programs may be accessed through a common consistent user interface. The analysis software may be software typically used to audit the performance or security of a computer attached to a network, or the sort used by intruders in order to access data protected from unauthorized users. If any reliability or security flaw is found 230, the system will automatically determine where the flaw is located in the virtual application environment, such as with a particular application. If no flaw is found, the user is informed 240 and a report is generated 250. In some embodiments, the system may design a patch to correct the flaw 260 or suggest a course of action to the user to remedy the flaw. If a patch has been designed, the system may test the patch on the virtual application environment 270 to determine whether the patch has been successful 280. If the patch is successful in the virtual application environment, the user may elect to implement the patch on the target system 290. If the patch has not been successful, the system will design another patch to attempt to remedy the flaw. Once the flaw has been corrected, the user may utilize the system to run the same tests or additional tests on the virtual application environment to ensure that the flaw has been corrected. The system will generate a report for the user detailing what actions have been taken 250. Once the user has determined the optimal way to fix the flaw, the user may then fix the flaw on the target system with only minimal interruption in usage of the target system.

While the user is running tests on the virtual application environment, the target system is free to be used by other users. This allows for increased productivity because of the lack of inoperative time, or “down time” necessary to test and modify the system. The data stored on the target system is also free from threat of being damaged by testing or simulated hacker attacks that are run on the virtual application environment. Neighboring systems are also insulated from inadvertent damage due to disruptive testing, as it is contained within the virtual network of the assurance system.

If no security flaws were found, the virtual application environment may be erased or it may be stored for comparison to another virtual application environment created from the same target machine at a later date.

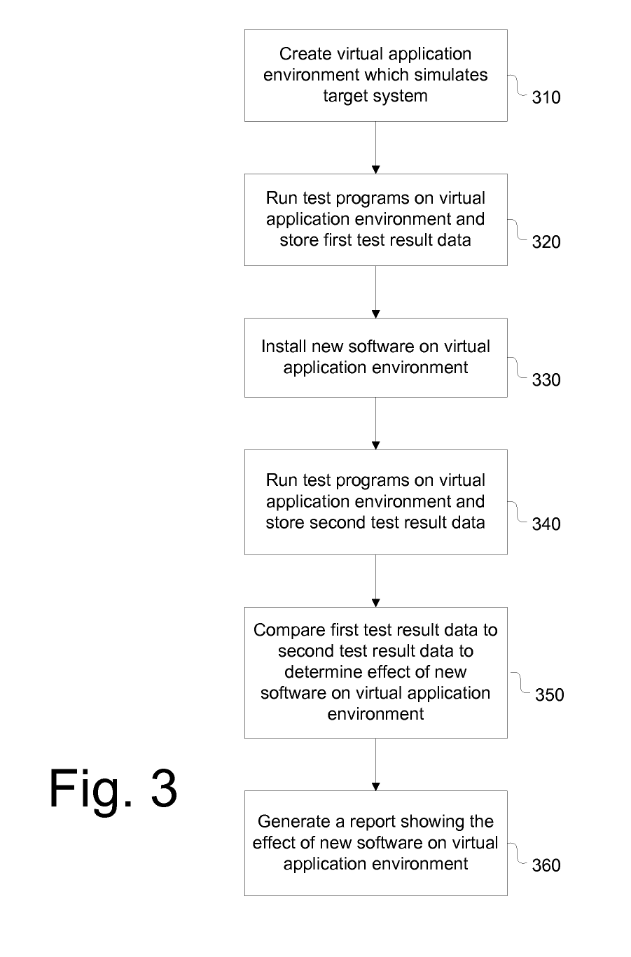

Another method according to the present invention is depicted in FIG. 3. A virtual application environment is created in the same manner as described above 310. The user may then run test programs on the virtual application environment to determine its efficiency and running environment 320. The user may then install new software or update existing software on the virtual application environment in order to determine its impact on the virtual application environment 330. Once the new software has been installed, the user may reboot the system to determine whether all of the applications and hardware are functioning properly. If any software application or piece of hardware is malfunctioning, the system will determine the cause of the problem and suggest a change to the user. The system will then run tests on the virtual application environment 340, compare the results to tests run on the virtual application environment before the software was installed 350, and create a comprehensive report detailing the changes to system configuration that occur as a result of the installation of new software 360. The report may contain information such as, for example, the amount of memory used by the new application or the amount of other resources used by the new application. If the user determines that the installation of the new software will not detrimentally affect the target system, the user may then install the software on the target system. The user interface may also provide the user with real-time reports such as usage of the machine's resources by any particular application.

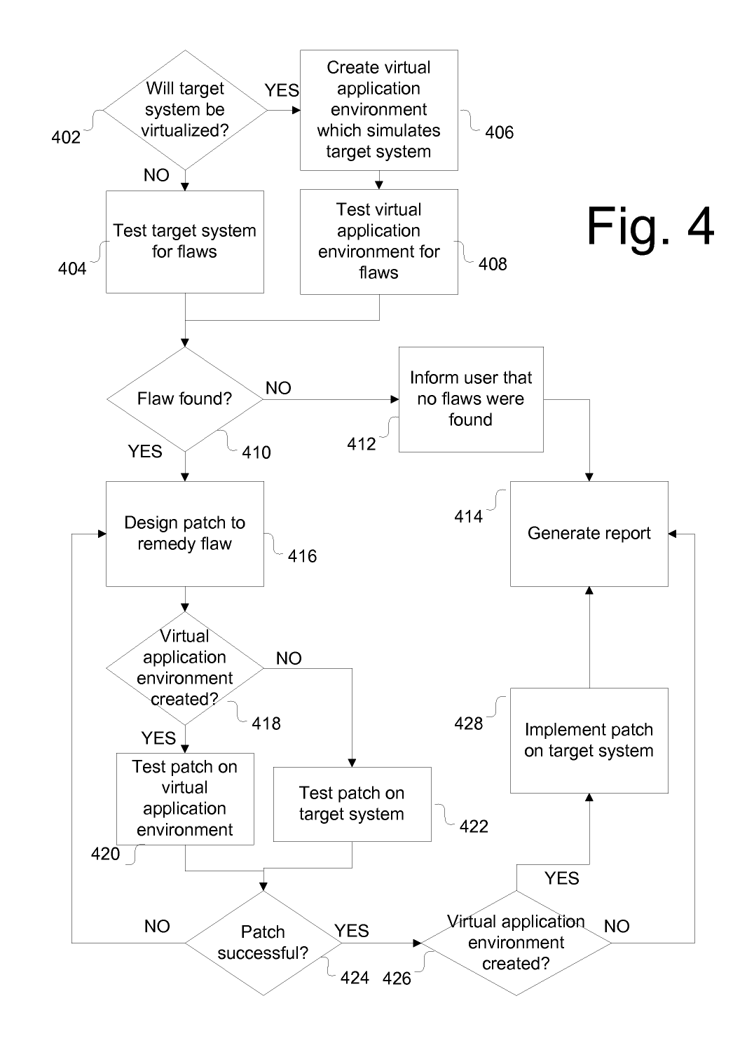

Another method according to the present invention is depicted in FIG. 4. The system depicted in FIG. 4 allows a user to utilize the testing capability of the assurance system without the necessity of creating a virtual application environment. A user first determines whether a target system will be virtualized 402. If not, the target environment will be tested without creating a virtual application environment 404. If the user decides to create a virtual application environment, one is created as discussed above 406. The virtual application environment is then tested for flaws 408. The assurance system determines if a flaw has been found 410. If no flaw has been found, the user is informed 412 and a report is generated 414 detailing the results of the testing for flaws. If a flaw is found, the assurance system will design a patch to remedy the flaw 416. The assurance system determines whether the flaw was found on a virtual application environment 418. If it has, then the assurance system will test the patch on the virtual application environment 420. If no virtual application environment has been created, the patch is tested on the target system 422. The assurance system will determine whether the patch has been successful 424. If the patch has not been successful, the assurance system will design another patch to remedy the flaw 416. If the patch has been successful, the assurance system will implement the patch on the target system 426 if it has not already been implemented on the target system and generate a report 414 detailing the flaw that was found and how it was remedied.

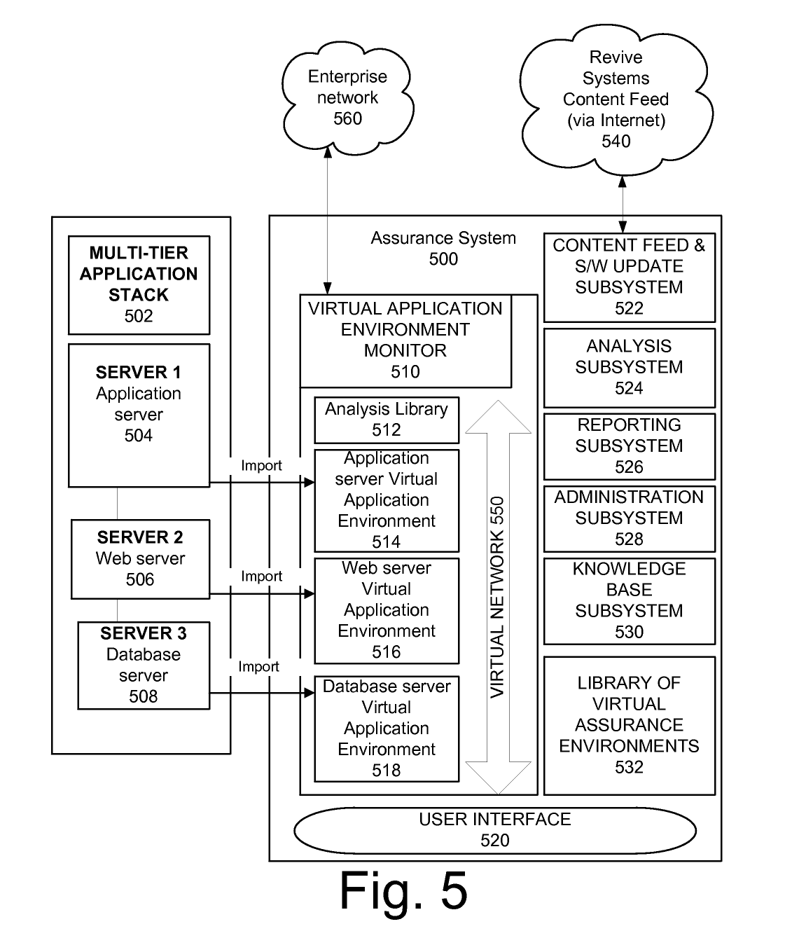

FIG. 5 is a system diagram showing the various components of an assurance system 500 according to the present invention. On the left side of the diagram, a multi-tier application stack 502 is shown. The application stack includes a plurality of servers, such as an application server 504, a web server 506, and a database server 508. These servers are imported into a assurance system that creates virtual application environments 514, 516, and 518 from the servers. Virtual application environments may be created on the assurance system from the application server, web server, and database servers. An analysis library 512 may contain one or more tests to be run on the assurance system or software to be implemented on the virtual application environment. The analysis library 512 may be updated over the content feed, which may be a connection to a network such as the Internet or an enterprise network 560. The assurance system may also have a virtual application environment monitor 510 that monitors the virtual application environments.

The assurance system 500 depicted in FIG. 5 may include a number of subsystems. The assurance system 500 may include a content feed and software update subsystem 522 that manages a feed of information 540 from a network such as the Internet to the virtual application environments. The content feed may be used to test the various application environments under network conditions, such as within a virtual network 550. The content feed may also be used to update the assurance system software. The assurance system may also include an analysis subsystem 524 that runs tests on the virtual application environments to assess their functionality. The reporting subsystem 526 generates reports concerning the functionality of the virtual application environments. The administration subsystem 528 manages the administration functions of the assurance system. A user may access the assurance system 500 and the virtual application environments stored thereupon using a user interface 520, which may be a graphical user interface. The assurance system may also include a knowledge base subsystem 530 and a library of virtual application environments 532.

All of the components or subsystems depicted in FIG. 5 may be on one physical device or they may be distributed over multiple devices. For instance, over time, the database of analysis results and reports, library of virtual application environments and/or the knowledge base may grow so large that these components may be moved to a dedicated database machine with a large amount of disk space. Some historical data may be moved to an archival store optimized for searching and reporting functions. When a database is optimized for reporting a large number of indices may be built which make retrieval queries efficient as the time frame for making updates to the database increases. Increasing the number of indices causes updates to consume additional system resources, as every update to a single entry in a database will also require updating multiple indices. Therefore a database optimized for retrieval queries is practical for historical data but not practical for storing the results of recently run tests.

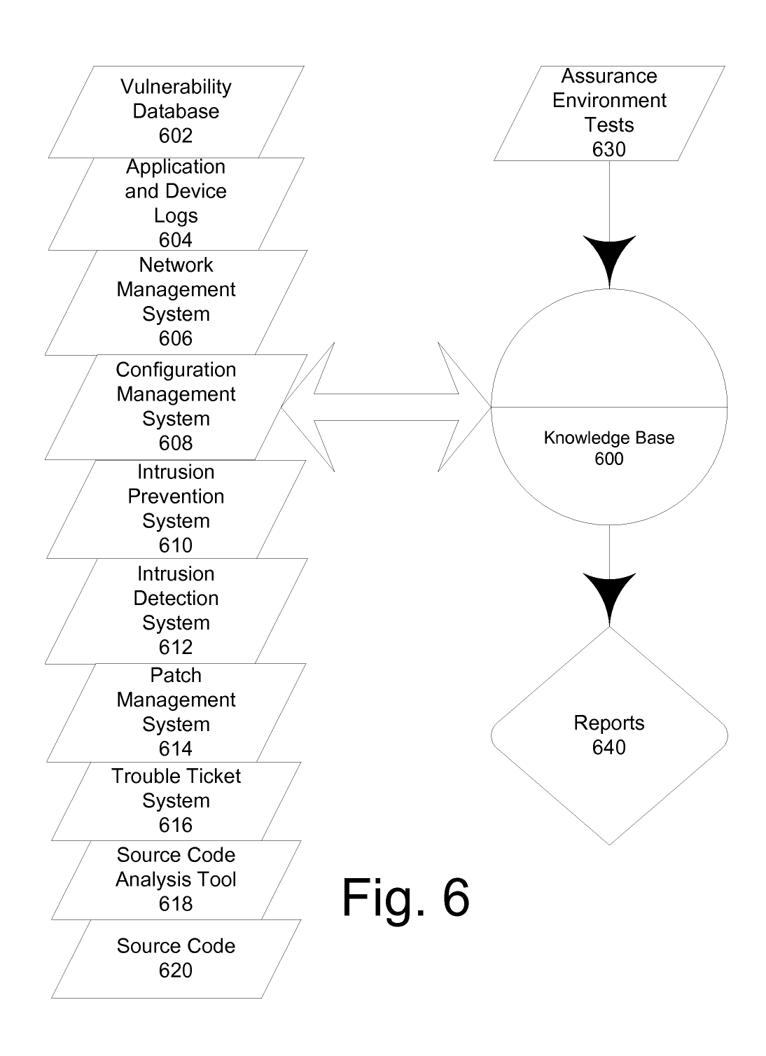

FIG. 6 depicts the knowledge base subsystem in communication with the various other systems of the present invention, including a vulnerability database 602, application and device logs 604, a network management system 606, a configuration management system 608, an intrusion prevention system 610, an intrusion detection system 612, a patch management system 614, a trouble ticket system 616, a source code analysis tool 618, and source code 620. The knowledge base may store assurance system tests 630 and reports 640 may be created from the data stored in the knowledge base 600. The knowledge base subsystem includes stored information regarding the tests run by the system on the present virtual application environment or on other virtual application environments. In a business environment, for example, the knowledge base subsystem may store the results of all tests that the assurance system has run on any virtual application environments created from any of the business's computers. The results may show patterns of failure in particular programs or similar problems experienced by multiple users. The knowledge base may be updated through a network such as the Internet to include information from various other systems. The knowledge base may also provide information on patterns of failure across the population of users of the assurance system, whether in the same or different organizations.

The knowledge base subsystem may be accessed through an interface by users without the creation of any virtual application environments if a user wishes to access test or installation information or if the user wishes to create reports concerning previous tests. For example, in a business environment a member of the accounting department may wish to know which particular software component installed on the various computer systems in the company has failed the most times. This may allow the user to evaluate the cost of maintaining the software and decide whether to purchase an upgrade to the software or to purchase different software.

The knowledge base may also store configuration data concerning one or more machines that are in communication with the assurance system, even if the machine has not been imported into a virtual application environment. The configuration data may be used to assess other machines, such as the virtual application environment, and provide configuration suggestions to the user. For example, if a user's machine is imported into the virtual application environment, the assurance system may analyze the configuration of the virtual application environment, compare it to configuration data stored in the knowledge base, and provide suggestions to the user for changing the configuration of their machine based on the data in the knowledge base. The suggestions may be in the form of a report and may include data such as, “There are 5 other machines connected to the same network as your machine. Three of them are utilizing Windows Vista as an operating system and are functioning 20% more efficiently than your machine. Based on this data, it is recommended that you upgrade your operating system to Windows Vista. Would you like to attempt this upgrade on the virtual application environment to evaluate the results of the upgrade on your physical machine?”

The knowledge base may also be used to provide the user with information regarding the possible outcomes of a particular action before an action is taken. For example, if a user attempts to upgrade the operating system, the system may warn the user, “Based on statistics stored in the knowledge base, 50% of users who attempted this action lost stored data. Do you want to utilize the assurance system to test the results of this upgrade before upgrading your machine?”

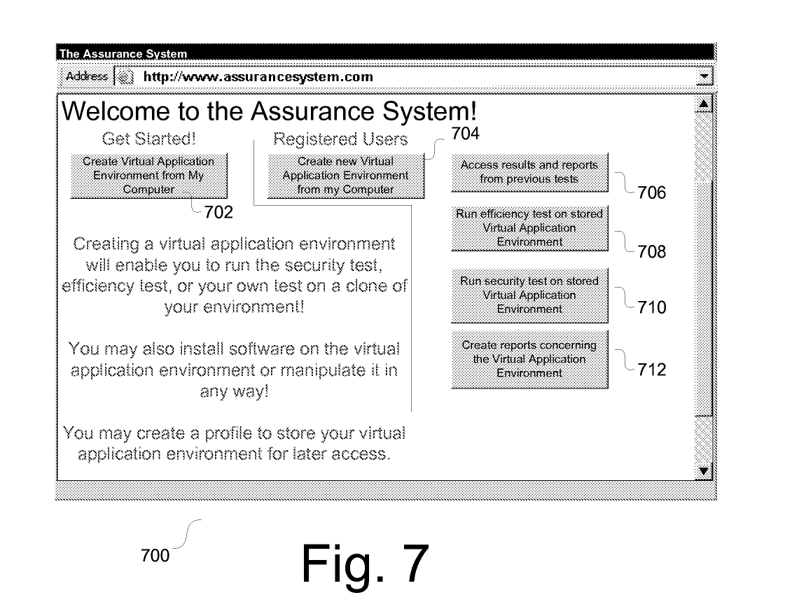

In one embodiment, software according to the present invention may create an entire virtual application environment from a target computer over the Internet. In this embodiment, a user accesses the software over the Internet, possibly in the form of an application programming interface or graphical user interface. FIG. 7 depicts one embodiment of a graphical user interface 700 according to the present invention. The user may provide the software with the necessary access to the target system by simply selecting a button 702. The software may then create a virtual application environment in a location separate from the user's target system by copying all of the necessary information over the Internet. The user interface will then provide the user with a set of tests or scripts that may be run on the virtual application environment over the Internet without interfering with the target system at all. The user interface will also provide the user with the ability to run user-defined tests or to simply access the virtual application environment to assess the results of a particular command or set of commands. For users that have previously registered or utilized the system, buttons or selections may be available to, for example, create a new virtual application environment 704, access results and reports from previous tests 706, run tests on stored virtual application environments 708 and 710, or create reports concerning a virtual application environment 712.

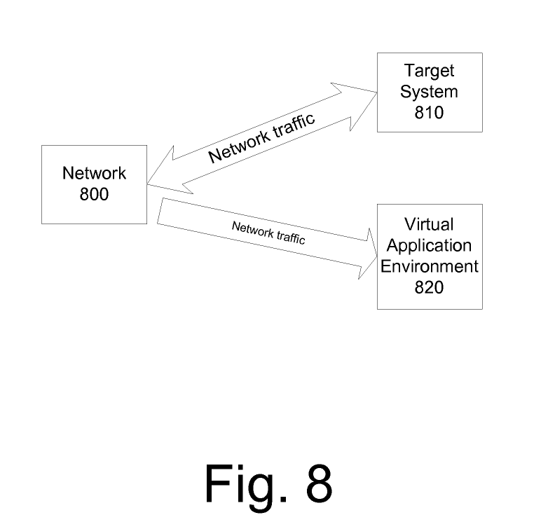

FIG. 8 depicts an embodiment wherein a virtual application environment 820 receives network traffic from a network 800. The network traffic is routed from the network 800 to both the target system 810 and the virtual application environment 820. Network traffic is not returned from the virtual application environment 820 to the network 800 to protect the network from duplicate transaction processing or any damage that may be caused by testing in the virtual application environment 820.

Because the installation of the new software occurs on the virtual application environment and not on the target system, productivity is not affected by a system crash or the destruction of data on the virtual application environment. A user is quickly able to tell whether the installation will disrupt normal operations, and opt not to conduct the installation on the target system. Because the virtual application environment is an exact clone of the target system, the user is able to tell exactly how the installation will affect the other applications and hardware on the target system.

Another method according to the present invention involves the creation and maintenance of a central repository of system fault and remediation information aggregated from the entire user community in an automated manner. In the course of using the system to identify changes, faults and security problems with a virtual application environment, the system may capture information on the components within a first user's environment, the nature of the fault, and resolution information contributed by the end user. This information may be edited to remove sensitive details and uploaded to a central repository, where an update to all other users' systems would be constructed. Then the new fault and mitigation data would be delivered over a network connection or recorded media to other users. At the point when a second user encounters a similar problem, the knowledge base in the second user's system could suggest the mitigation strategy previously identified by the first user.

The reports created by the system may be user-defined reports to present a user with the particular information that the user feels is most relevant to the use of the system. The system may also generate standardized reports for upload to a database that is shared with other systems so that any one system can access reports for a particular application or a particular configuration as implemented on other systems.

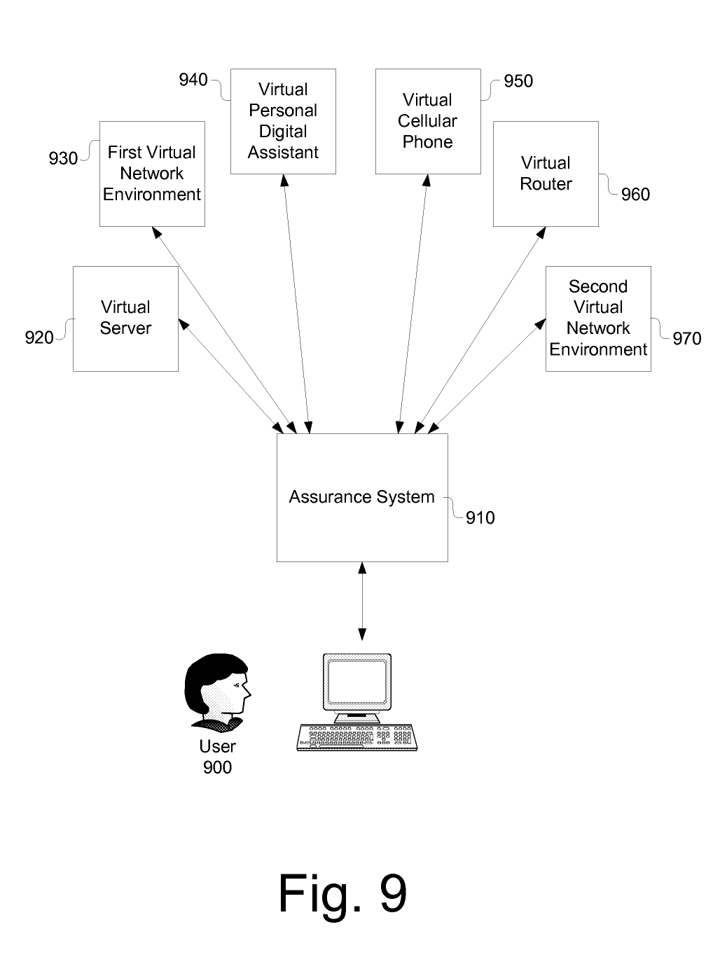

FIG. 9 depicts one embodiment of the present invention that allows a user 900 to create and manipulate a plurality of virtual application environments through one assurance system 910. In this embodiment, one assurance system 910 oversees a virtual server 920, a first virtual network environment 930, a virtual personal digital assistant 940, a virtual cellular telephone 950, a virtual router 960, and a second virtual network environment 970. The user may run tests or create reports concerning all of these virtual application environments through one assurance system.

In one example of this embodiment, a network administrator wishes to create a new workstation for a new employee who will review a company's financial records for any irregularity. The network administrator may be concerned about the impact on other network users of deploying the additional workstation that accesses the company's financial records. To determine the impact the new workstation will have, the network administrator may create a virtual application environment that includes the financial records database, the software footprint of the workstation, and software footprints of a plurality of existing workstations that utilize the financial records database. In the assurance system, the network administrator may utilize the virtual new workstation to access the financial records database at the same time as the virtual application environments and determine how the database is affected by the addition of the new workstation.

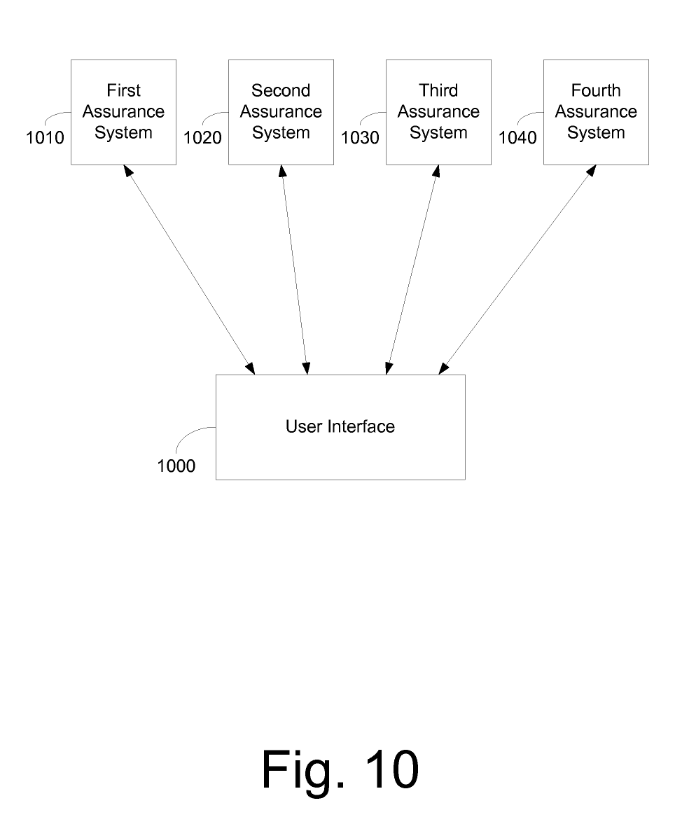

A user may be provided with access to multiple assurance systems through one interface. An example of this embodiment is depicted in FIG. 10. In this embodiment, the user may access the multiple assurance systems 1010, 1020, 1030, and 1040 through a single user interface 1000. The user interface may be present on the machine being used by the user or may be accessed by the user through a network such as the Internet. The multiple assurance systems may be accessed through a network such as the Internet. For example, the user may access the user interface over the Internet and be provided with access to multiple assurance systems present anywhere in the world that are also connected to the Internet.

The multiple assurance systems depicted in FIG. 10 may be in various different physical locations. Each assurance system may be distributed across numerous devices in different physical locations or across numerous memory devices in one physical location. In one embodiment, an assurance system will utilize a load balancing approach to distribute assurance systems across physical machines connected to a network that are underutilized or that have an abundance of free resources.

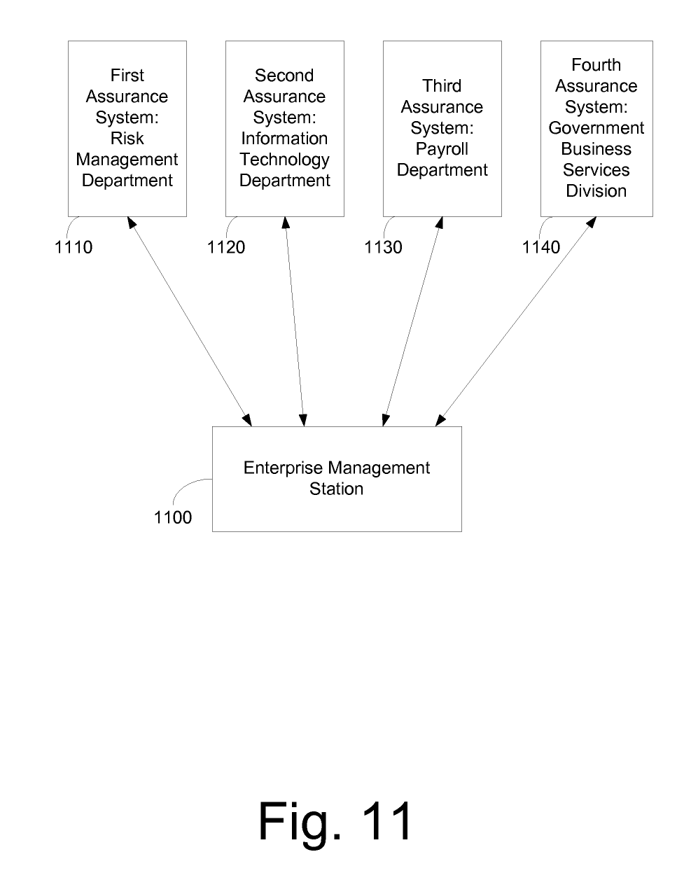

As depicted in FIG. 11, the present invention may further comprise an Enterprise Management Station 1100. The Enterprise Management Station 1100 is an application which accesses and controls a plurality of assurance systems. In the example depicted in FIG. 11, the Enterprise Management Station 1100 has access to a first assurance system 1110, a second assurance system 1120, a third assurance system 1130, and a fourth assurance system 1140. Each of these assurance systems represents a separate system of an organization, such as the first assurance system which is a virtual application environment created from the organization's risk management department. Each assurance system in this embodiment may be used independently or used together as one large assurance environment. In this example, the Enterprise Management Station 1100 presents a user with a unified view so that a set of assurance environments may be configured and managed as one assurance environment from a single interface. This may be required, for example, if the hardware of the device hosting a particular assurance environment is sufficient to support only one of the multiple applications to be tested.

The Enterprise Management Station 1100 depicted in FIG. 11 allows a user to create reports concerning all of the assurance systems shown as a single enterprise report. Each department of the organization may use their own assurance environment but results of their tests may be sent to the Enterprise Management Station 1100. The Enterprise Management Station 1100 may also be able to disseminate information gathered from a particular assurance system to other assurance systems. Thus, the Enterprise Management Station 1100 may be used to coordinate and disseminate content and updates across the enterprise. The Enterprise Management Station 1100 may further be used to coordinate testing and upgrades of the entire enterprise.

One example of an embodiment of the present invention on a particular hardware configuration will now be described. An assurance system may create a virtual application environment on a host server that has four 64-bit central processing unit cores, such as AMD Opteron 2210 or Intel Xeon 5150 central processing units, 8 gigabytes of memory, and one terabyte of disk space. This host server may be used to virtualize a three-tier web application which has a 32-bit web server with 1 gigabyte of memory and 100 gigabytes of disk space, a 64-bit application server with 2 gigabytes of memory and 250 gigabytes of disk space, and a 64-bit database server with four gigabytes of memory and 500 gigabytes of disk space. In this example, the assurance system may run each of the three tiers as a virtual application environment inside the one host server.

The three-tier web application described above may also be virtualized by an assurance system with a completely different hardware configuration consisting of three smaller servers, each smaller server having two 64-bit central processing units, such as AMD Opteron 2210s or Intel Xeon 5150s, 4 GB of memory, and 600 GB of disk space. In this example, the assurance system would be a cluster of three machines presented to the user as a single assurance system interface. Each smaller server would be responsible for virtualizing one of the physical servers. The assurance system software would manage the three smaller servers.

The host server may partition storage and memory space to be used by the assurance system, and separate storage and memory space to be used for the operations of the host server. The host may also create a virtual network to allow virtual guests to connect with the virtualized servers. The host may additionally create a virtual network to allow a user to access the virtual servers or to access the assurance system applications.

In one embodiment, software is contained on a portable memory device such as a DVD or flash drive which is automatically loaded when the memory device is accessed by a target machine. The software will gather data about the target machine, establish a connection with the host server, and make virtual application environments of the target machine in assurance system on the host server. For example, a user may purchase a DVD, insert the DVD into his or her personal computer, and the DVD will automatically load, contact the provider of the DVD through the Internet, send configuration information about the personal computer through the Internet to the provider, and manage copying of the personal computer to an assurance system on a server managed by the provider.

In one example of the present invention, a system administrator may create a virtual application environment from a new workstation deployed on a network to preserve the original configuration and storage of the workstation before it is utilized. Three months after the workstation has been activated, the system administrator may create a second virtual application environment from the workstation and compare the second virtual application environment to the stored first virtual application environment to determine what has changed on the workstation since it was activated. The system administrator may create comprehensive reports on the current configuration of the second virtual application environment and the differences between the second virtual application environment and the stored first virtual application environment. If problems have been detected with the workstation, the system administrator may run tests on both the second virtual application environment and the first virtual application environment to determine the cause of the problems. The system administrator may reverse some of the configuration changes in the second virtual application environment and re-run the tests to isolate the problem and determine how to modify the workstation to eliminate the problem.

In another example of the present invention, a system administrator may wish to determine whether several supposedly identical workstations are actually identical. To accomplish this analysis, the system administrator creates a virtual application environment from each of the workstations. The system administrator then compares each virtual application environment and runs tests on the virtual application environments to produced a comprehensive list of the differences between the virtual application environments. The system administrator may use this report to determine how to modify the physical workstations to render the workstations all identical.

In another example of the present invention, a system administrator may wish to evaluate how a new e-mail application will function on various workstations connected to a network. The system administrator creates virtual application environments from three workstations connected to the network and installs the new e-mail application on the virtual application environments. The system administrator then routes traffic from the network to the virtual application environments and runs tests on the virtual application environments to evaluate the efficiency of the machines as a whole, the speed of the new e-mail application, and the actual memory used by the new e-mail application. The system administrator may run tests on the workstations and compare the results to tests run on the virtual application environments to determine the precise effects of the e-mail application on the workstations.

As these and other variations and combinations of the features discussed above can be utilized without departing from the present invention as defined by the claims, the foregoing description of the preferred embodiment should be taken by way of illustration rather than by way of limitation of the invention set forth in the claims.

What is claimed is:

1. A method for evaluating a first computer environment comprising:
(a) copying data stored in the first computer environment to a virtual computer environment;
(b) copying configuration data from the first computer environment to the virtual computer environment;
(c) emulating components from the first computer environment in the virtual computer environment;
(d) analyzing the first computer environment and analyzing the virtual computer environment using a software program located in the virtual computer environment
(e) comparing the first computer environment to the virtual computer environment at a first point in time based on the analysis of the first computer environment and the analysis of the virtual computer environment.

2. The method of claim 1, further comprising comparing the first computer environment to the virtual computer environment at a second point in time.

3. The method of claim 2, further comprising creating a report based on the comparing of the first computer environment to the virtual computer environment at the first point in time and the comparing of the first computer environment to the virtual computer environment at the second point in time.

4. The method of claim 3, wherein the comparing of the first computer environment to the virtual computer environment at the first point in time yields a first set of results, and the comparing of the first computer environment to the virtual computer environment at the second point in time yields a second set of results, and further comprising comparing the first set of results to the second set of results.

5. The method of claim 1, further comprising installing a hardware component on the virtual computer environment.

6. The method of claim 5, wherein the hardware component is a virtual hardware component.

7. The method of claim 5, further comprising comparing the first computer environment to the virtual computer environment a second time.

8. The method of claim 1, wherein the virtual computer environment is created on dissimilar hardware from the hardware of the first computer environment.

9. The method of claim 1, wherein the emulating of components from the first computer environment in the virtual computer environment comprises emulating components in the virtual computer environment that are different than the components of the first computer environment.

10. The method of claim 1, further comprising:
(e) modifying the virtual computer environment; and
(f) comparing the first computer environment to the virtual computer environment a second time.

11. The method of claim 10, wherein modifying the virtual computer environment comprises installing software on the first computer environment.

12. The method of claim 10, wherein modifying the virtual computer environment comprises installing a hardware component on the first computer environment.

13. The method of claim 10, wherein modifying the virtual computer environment comprises adding data to the virtual computer environment.

14. The method of claim 1, further comprising routing simulated network traffic to the virtual computer environment.

15. The method of claim 1, further comprising routing network traffic to the virtual computer environment.

16. The method of claim 1, further comprising removing software from the virtual computer environment.

17. The method of claim 1, further comprising removing software from the first computer environment.

18. A system for evaluating a first computer system, comprising:
(a) a first computer system including a first memory device wherein the first memory device includes data and configuration settings;
(b) a second computer system, including a second memory device wherein the data and configuration settings from the first memory device are copied to the second memory device to emulate the first computer system in the second computer system; and
(c) a computer software program on the second computer system that is used to compare the first computer system to the second computer system.

19. The system of claim 18, further comprising additional software installed on the second computer system which is not present on the first computer system.

20. The system of claim 18, further comprising an additional hardware device installed on the second computer system which is not present on the first computer system.

21. The system of claim 18, further comprising a report generated by the computer software program.

22. The system of claim 18, wherein the results of the comparison performed by the computer software program are stored on the second computer system.

23. The system of claim 18, wherein the computer software program runs a script on the second computer system.

24. The system of claim 18 further comprising a hardware device connected to the first computer system wherein the computer software program compares the first computer system with the hardware device to the second computer system with the hardware device.

25. A method of comparing a first computer environment with a second computer environment comprising:
(a) copying data stored in the first computer environment to the second computer environment;
(b) copying applications stored in the first computer environment to the second computer environment;
(c) comparing the first computer environment to the second computer environment using software installed on the second computer environment.

26. The method of claim 25, further comprising installing software on the second computer environment that is not present on the first computer environment.

27. The method of claim 25, further comprising installing a hardware component on the second computer environment that is not present on the first computer environment.

28. The method of claim 25, further comprising compensating for the effects on the comparison resulting from the software being installed on the second computer environment.

29. The method of claim 18, further comprising compensating for the effects on the comparing resulting from the computer software program on the second computer system.

30. The method of claim 1, further comprising compensating for the effects on the comparing resulting from the software program located in the virtual computer environment.

31. The method of claim 1, further comprising modifying the first computer environment based on the analysis of the first computer environment and the analysis of the virtual computer environment.

32. The method of claim 18, further comprising modifying the first computer system based on the comparing of the first computer system to the second computer system.

33. The method of claim 25, further comprising modifying the first computer environment based on the comparing of the first computer environment to the second computer environment.

34. The method of claim 25 further comprising providing access from the second computer environment to at least one hardware device accessible by the first computer environment.

35. The method of claim 25 further comprising providing access from the second computer environment to at least one storage location accessible by the first computer environment.
